(19) United States
(12) Patent Application Publication
(10) Pub. No.: US 2016/0198510 A1
(43) Pub. Date: Jul. 7, 2016

(54) DEVICE-TO-DEVICE (D2D) ASSISTANCE TO CELLULAR NETWORK COMMUNICATION

(71) Applicant: Marvell International Ltd., Hamilton (BM)

(72) Inventors: Yona Perets, Ra'anana (IL); Ezer Melzer, Tel Aviv (IL); Shimon Moshavi, Bet Shemesh (IL)

(21) Appl. No.: 14/975,781

(22) Filed: Dec. 20, 2015

Related U.S. Application Data
(60) Provisional application No. 62/100,388, filed on Jan. 6, 2015.

(51) Int. Cl. H04W 76/02

(52) U.S. Cl. CPC H04W 76/023

(57) ABSTRACT

A method for communication includes receiving in a first cellular communication terminal signals from a cellular communication network, and deriving by the first cellular communication terminal, from the received signals, one or more parameters for assisting in establishing communication with the cellular communication network. The one or more parameters are relayed from the first cellular communication terminal to a second cellular communication terminal that is not currently associated with the cellular communication network, over a direct device-to-device (D2D) link between the first and second cellular communication terminals, the D2D link not traversing the cellular communication network.

### CROSS-REFERENCE TO RELATED APPLICATIONS

This application claims the benefit of U.S. Provisional Patent Application 62/100,388, filed Jan. 6, 2015, whose disclosure is incorporated herein by reference.

### FIELD OF THE DISCLOSURE

The present disclosure relates generally to wireless communication, and particularly to methods and systems for cellular and Device-to-Device (D2D) communication.

### BACKGROUND

Some cellular communication protocols specify Device-to-Device (D2D) services in which wireless communication terminals can communicate directly with one another. For example, D2D services in Long-Term Evolution (LTE) networks have been studied, in “3^{rd} Generation Partnership Project; Technical Specification Group Radio Access Network; Study on LTE Device to Device Proximity Services; Radio Aspects (Release 12),” TR 36.843, version 12.0.1, March, 2014, which is incorporated herein by reference.

The description above is presented as a general overview of related art in this field and should not be construed as an admission that any of the information it contains constitutes prior art against the present patent application.

### SUMMARY

An embodiment that is described herein provides a method for communication, including receiving in a first cellular communication terminal signals from a cellular communication network, and deriving by the first cellular communication terminal, from the received signals, one or more parameters for assisting in establishing communication with the cellular communication network. The one or more parameters are relayed from the first cellular communication terminal to a second cellular communication terminal that is not currently associated with the cellular communication network, over a direct device-to-device (D2D) link between the first and second cellular communication terminals, the D2D link not traversing the cellular communication network.

In some embodiments, the method further includes establishing communication between the second cellular communication terminal and the cellular communication network using the relayed one or more parameters. In some embodiments, relaying the one or more parameters includes relaying synchronization information relating to a base station of the cellular communication network. In an example embodiment, relaying the synchronization information includes relaying one or more of: a frequency of the base station and a timing of the base station.

In an embodiment, relaying the one or more parameters includes relaying an identifier of a base station of the cellular communication network. In another embodiment, relaying the one or more parameters includes relaying a parameter of a same base station from which the first cellular communication terminal receives the signals. Additionally or alternatively, relaying the one or more parameters includes relaying a parameter of a second base station, which differs from a first base station from which the first cellular communication terminal receives the signals.

In an embodiment, deriving the one or more parameters includes receiving at least one of the parameters via signaling from the cellular communication network. Additionally or alternatively, deriving the one or more parameters includes estimating at least one of the parameters based on the received signals.

There is additionally provided, in accordance with an embodiment that is described herein, a communication apparatus including a transceiver and a processor. The processor is configured to receive signals using the transceiver from a cellular communication network, to derive from the received signals one or more parameters for assisting in establishing communication with the cellular communication network, and to relay the one or more parameters using the transceiver to a peer communication apparatus that is not currently associated with the cellular communication network, over a direct device-to-device (D2D) link between the communication apparatus and the peer communication apparatus, the D2D link not traversing the cellular communication network.

In some embodiments, a mobile communication terminal includes the disclosed apparatus. In some embodiments, a chipset for processing signals in a mobile communication terminal includes the disclosed apparatus.

There is additionally provided, in accordance with an embodiment that is described herein, a communication apparatus including a transceiver and a processor. The processor is configured to receive using the transceiver from a peer communication apparatus one or more parameters for assisting in establishing communication with a cellular communication network, the parameters relayed between the communication apparatus and the peer communication apparatus over a direct device-to-device (D2D) link that does not traverse the cellular communication network, and to establish, using the transceiver, communication with the cellular communication network using the relayed one or more parameters.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a wireless communication system, in accordance with an embodiment that is described herein; and

FIG. 2 is a flow chart that schematically illustrates a method for wireless communication, in accordance with an embodiment that is described herein.

### DETAILED DESCRIPTION OF EMBODIMENTS

Embodiments that are described herein provide improved methods and systems for assisting the establishment of cellular communication between wireless communication terminals and a base stations, using direct Device-to-Device (D2D) links between terminals.

The embodiments described herein refer mainly to LTE cellular networks, and therefore base stations are also referred to herein as eNodeB, and terminals are also referred to herein as User Equipment (UE). The disclosed techniques, however, are applicable in various other suitable communication protocols.

In some embodiments, a first UE receives signals from a base station of a cellular network. As part of this communication, the first UE receives from the cellular network, or estimates based on the signals received from the network, one or more parameters that assist in establishing communication with the cellular network. In various embodiments such parameters comprise, for example, synchronization information such as the frequency and/or timing of the base station or of a neighbor base station, an identifier (e.g., CELL_ID) of the base station or of a neighbor base station, or any other suitable parameters.

In an embodiment, the first UE relays the parameters to a second UE that is not currently associated with the cellular network, over a direct D2D link that does not traverse the cellular communication network. In the context of the present patent application and in the claims, the term “a D2D link that does not traverse the cellular network” means that the information conveyed over the D2D link is not received and retransmitted by any of the base stations of the cellular network. Instead, the signals carrying the D2D link are transmitted by the first UE, and the second UE receives these very signals.

In an embodiment, the second UE uses the relayed parameters to establish communication with the cellular network. In an embodiment, the parameters relayed over the D2D link enable the second UE to establish communication with the cellular network more quickly, with a higher probability of success, and with lower power consumption.

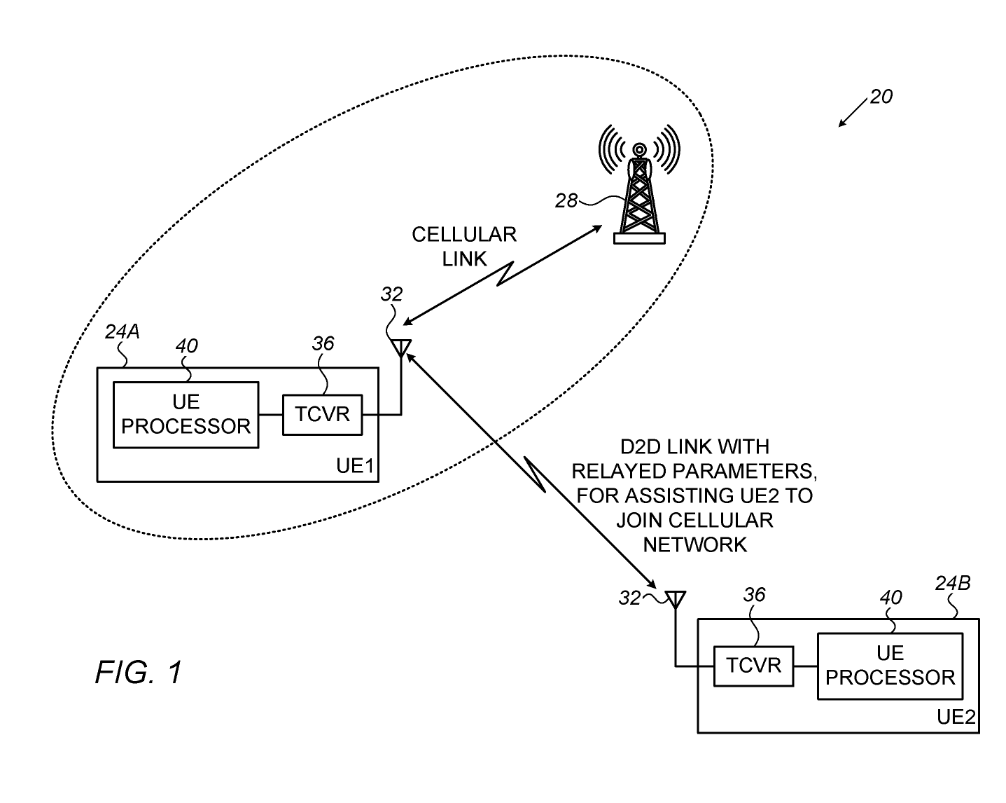

FIG. 1 is a block diagram that schematically illustrates a wireless communication system 20, in accordance with an embodiment that is described herein. System 20 comprises cellular communication terminals 24 (in the present example LTE UEs), and one or more base stations 28 (BSs—in the present example LTE eNodeBs). For the sake of clarity, the embodiment of FIG. 1 shows a single base station 28 and two UEs 24A and 24B (denoted UE1 and UE2, respectively). Real-life systems typically comprise a large number of base stations and a large number of UEs.

UEs 24 comprise, for example, cellular phones, smartphones, wireless-enabled computing devices, wireless-enabled Internet-of-Things (IoT) or Machine-Type Communication (MTC) devices, or any other suitable type of wireless communication terminal.

In an embodiment, each UE 24 is configured to conduct two types of communication Cellular communication with the cellular network via a base station 28, and direct Device-to-Device (D2D) communication with peer UEs. At a given point in time, a UE may be engaged in any one of these types of communication, or in both.

In the embodiment of FIG. 1, each UE 24 comprises one or more antennas 32, a transceiver (TCVR, i.e., transmitter-receiver) 36 and a UE processor 40. Antennas 32 and transceiver 36 are used for transmitting and receiving Radio Frequency (RF) signals for communicating over a cellular link with a base station and/or a D2D link with a peer UE. UE processor 40 performs the various management and control tasks of the UE.

In some embodiments, UE processor 40 is configured to receive signals from base stations 28, and to derive and relay parameters for assisting peer UEs to establish cellular communication with the cellular network. Additionally or alternatively, UE processor 40 is configured to establish cellular communication with base stations based on parameters relayed from peer UEs. Example methods for relaying parameters and for establishing cellular communication using relayed parameters are described in detail below.

The UE and system configurations shown in FIG. 1 are example configurations, which are depicted solely for the sake of clarity. In alternative embodiments, any other suitable UE and/or system configuration can also be used. Some UE and system elements that are not mandatory for understanding of the disclosed techniques have been omitted from the figure for the sake of clarity.

The different elements of UE 24 are typically implemented using dedicated hardware, such as using one or more Application-Specific Integrated Circuits (ASICs), Field-Programmable Gate Arrays (FPGAs) and/or RF Integrated Circuits (RFICs). Alternatively, some UE elements, e.g., UE processor 40, may be implemented using software executing on programmable hardware, or using a combination of hardware and software elements. In some embodiments, some or all of the elements of UE 24 are fabricated in a chip-set.

In some embodiments, UE processor 40 is implemented using a programmable processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

In some embodiments, at a certain point in time, UE1 is associated with the cellular network but UE2 is not. The term “associated with the cellular network” means that UE1 is registered with the cellular network, synchronized with the cellular network and receives signals from a base station 28 of the cellular network, but not necessarily engaged in any active communication session via the cellular network.

In some cases, UE2 is not associated with the cellular network because it is not within the coverage area of any base station 28. In other cases, UE2 is not associated with the cellular network because it has recently been powered-up, because it is currently associated with another cellular network, or for any other reason.

In an embodiment, UE1 assists UE2 in establishing communication with the cellular network, by relaying one or more parameters relating to the cellular network over the direct D2D link between UE1 and UE2. Example parameters and their use are described below.

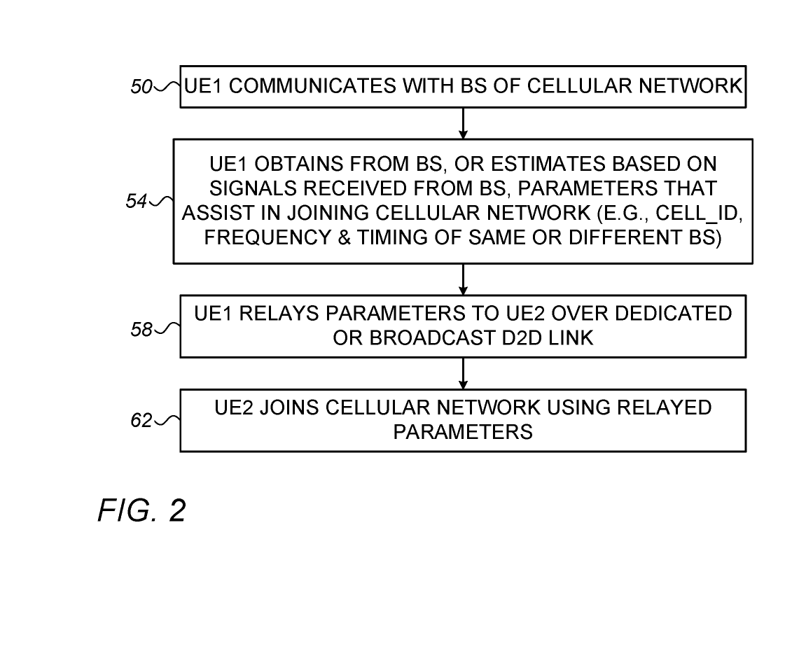

FIG. 2 is a flow chart that schematically illustrates a method for wireless communication, in accordance with an embodiment that is described herein. The method begins with UE1 communicating with base station (BS) 28 of the cellular network, at a cellular communication operation 50. Communication is conducted by UE processor 40 via transceiver 36.

As noted above, UE1 need not necessarily conduct calls or other communication sessions via the cellular network. For example, in an embodiment, UE1 is idle and merely receives signals that maintain its synchronization and association with the cellular network.

At a parameter derivation operation 54, UE processor 40 of UE1 derives one or more parameters relating to the cellular network from the signals received from base station 28. The parameters in question are helpful to UEs in establishing communication with the cellular network. The parameters may relate to the same base station with which UE1 communicates, or to a different base station of the cellular network.

Several non-limiting examples of parameters that assist establishing communication comprise synchronization information such as the frequencies and/or timing of one or more base stations, identifiers (e.g., CELL_IDs) of one or more base stations, respective power levels with which the signals of one or more base stations are received by UE1, respective path losses between one or more base stations and UE1, or any other suitable parameters. The parameters may relate to the same base station from which UE1 receives the signals, and/or to one or more other base stations. In various embodiments, UE1 may derive any suitable number of parameters of any suitable type.

In an embodiment, UE processor 40 of UE1 obtains one or more of the parameters from signaling messages transmitted by the base station. CELL_ID(s) of neighbor cell(s), for example, may be signaled and consequently derived in this manner. Additionally or alternatively, UE processor 40 of UE1 estimates one or more of the parameters from the signals received from the base station. CELL_ID and fine timing and/or frequency offsets are typically derived in this manner.

At a relaying operation 58, UE1 sends the derived parameters to UE2 over the direct (dedicated or broadcast) D2D link. When communicating over the D2D link, transceiver 36 of UE2 receives the signals transmitted by transceiver 36 of UE1. UE processor 40 of UE2 extracts the relayed parameters from the signals received over the D2D link.

In one embodiment, UE1 transmits the parameters to UE2 on a dedicated point-to-point D2D link that is set-up between the two UEs. In another embodiment, UE1 broadcasts the parameters in a broadcast D2D transmission, which is received by UE2 and possibly by other UEs. Both embodiments are regarded herein as ways of relaying the parameters over a direct D2D link from UE1 to UE2.

At a network joining operation 62, UE processor 40 of UE2 joins the cellular network using the parameters relayed from UE1. For example, by being aware of the CELL_IDs, frequencies and/or timing of one or more nearby base stations 28, UE2 is able to reduce the time needed to search for and synchronize with the base station signals.

Although the embodiments described herein mainly address 3GPP LTE systems (from Release 12 onwards), the methods and systems described herein can also be used in other applications.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for communication, comprising:
in a first cellular communication terminal, receiving signals from a cellular communication network;
deriving by the first cellular communication terminal, from the received signals, one or more parameters for assisting in establishing communication with the cellular communication network; and
relaying the one or more parameters from the first cellular communication terminal to a second cellular communication terminal that is not currently associated with the cellular communication network, over a direct device-to-device (D2D) link between the first and second cellular communication terminals, the D2D link not traversing the cellular communication network.

2. The method according to claim 1, comprising establishing communication between the second cellular communication terminal and the cellular communication network using the relayed one or more parameters.

3. The method according to claim 1, wherein relaying the one or more parameters comprises relaying synchronization information relating to a base station of the cellular communication network.

4. The method according to claim 3, wherein relaying the synchronization information comprises relaying one or more of: a frequency of the base station and a timing of the base station.

5. The method according to claim 1, wherein relaying the one or more parameters comprises relaying an identifier of a base station of the cellular communication network.

6. The method according to claim 1, wherein relaying the one or more parameters comprises relaying a parameter of a same base station from which the first cellular communication terminal receives the signals.

7. The method according to claim 1, wherein relaying the one or more parameters comprises relaying a parameter of a second base station, which differs from a first base station from which the first cellular communication terminal receives the signals.

8. The method according to claim 1, wherein deriving the one or more parameters comprises receiving at least one of the parameters via signaling from the cellular communication network.

9. The method according to claim 1, wherein deriving the one or more parameters comprises estimating at least one of the parameters based on the received signals.

10. A communication apparatus, comprising:
a transceiver; and
a processor, which is configured to receive signals using the transceiver from a cellular communication network, to derive from the received signals one or more parameters for assisting in establishing communication with the cellular communication network, and to relay the one or more parameters using the transceiver to a peer communication apparatus that is not currently associated with the cellular communication network, over a direct device-to-device (D2D) link between the communication apparatus and the peer communication apparatus, the D2D link not traversing the cellular communication network.

11. The apparatus according to claim 10, wherein the processor is configured to relay synchronization information relating to a base station of the cellular communication network.

12. The apparatus according to claim 11, wherein the processor is configured to relay one or more of: a frequency of the base station and a timing of the base station.

13. The apparatus according to claim 10, wherein the processor is configured to relay an identifier of a base station of the cellular communication network.

14. The apparatus according to claim 10, wherein the processor is configured to relay a parameter of a same base station from which the cellular apparatus receives the signals.

15. The apparatus according to claim 10, wherein the processor is configured to relay a parameter of a second base station, which differs from a first base station from which the cellular apparatus receives the signals.

16. The apparatus according to claim 10, wherein the processor is configured to receive at least one of the parameters via signaling from the cellular communication network.

17. The apparatus according to claim 10, wherein the processor is configured to estimate at least one of the parameters based on the received signals.

18. A mobile communication terminal comprising the apparatus of claim 10.

19. A chipset for processing signals in a mobile communication terminal, comprising the apparatus of claim 10.

20. A communication apparatus, comprising:
a transceiver; and
a processor, which is configured to receive using the transceiver from a peer communication apparatus one or more parameters for assisting in establishing communication with a cellular communication network, the parameters relayed between the communication apparatus and the peer communication apparatus over a direct device-to-device (D2D) link that does not traverse the cellular communication network, and to establish, using the transceiver, communication with the cellular communication network using the relayed one or more parameters.
